(19) United States
(12) Patent Application Publication
(10) Pub. No.: US 2013/0111580 A1
(43) Pub. Date: May 2, 2013

(54) METHOD FOR PROVIDING COMPUTER-BASED AUTHENTICATION UTILIZING GESTURE BIOMETRICS

(71) Applicant: John C. Checco, Stony Point, NY (US)

(72) Inventor: John C. Checco, Stony Point, NY (US)

(73) Assignee: Checco Services, Inc., Stoney Point, NY (US)

(21) Appl. No.: 13/286,577

(22) Filed: Nov. 1, 2011

(51) Int. Cl. G06F 7/04

(52) U.S. Cl. 726/19

(57) ABSTRACT

A method and system looks for patterns in a series of gesture data samples to determine consistency or inconsistency within the data sample. One embodiment includes device authentication using a unique biometric algorithm that provides biometrically enhanced gesture-based authentication using a software only solution. In this embodiment, the system and method provides a mechanism to gather user gesture timing data, and to analyze and abstract the data into a non-repudiated template against which future gesture timings can be verified.

### TECHNICAL FIELD OF THE INVENTION

The present invention relates to computer authentication and more particularly, to a unique gesture biometric algorithm that provides bio-metrically enhanced computer-based authentication using a software only solution thereby providing a mechanism to gather user gesture information and timings, which can analyze and abstract the data into a non-repudiated template against which future gestures and gesture timings can be verified for purposes of user authentication.

### BACKGROUND OF THE INVENTION

Gesture biometrics refers to the act of user authentication based not only on what gestures a user performs, but how the user performs those gestures. Some experts classify this technology as a behavioral rather than a physical biometric. “Behavioral biometrics” refers to the collection, classification, storage, retrieval, and dissemination of recorded actions of a user. Whereas “physical biometrics” refers to the statistical analysis of biological observations and phenomena. In layman's terms, physical biometrics provides an absolute measurement of biological aspects of a user that determine identity, such as DNA, Retina, Fingerprint and Vein structure.

Behavioral biometrics provides a confidence measurement of characteristic traits exhibited by a user that can determine identity, such as speech Recognition, Handwriting Analysis and Keystroke Biometrics.

Biometrics recognizes that we are all different in our physical makeup, and it is possible to identify people based on these differences. Hair color, height, and the sound of a voice are all examples of how people are different from each other. Combined, these differences create our identity and make us unique from each other. Biometrics measures aspects of our make-up, and uses those measurements in order to identify us.

Currently, there exists a wide array of authentication systems ranging from high-risk, such as user-id/password plaintext authentication, to low-risk hardware-based iris and fingerprint biometric recognition systems. In addition, there are existing academic as well as commercial algorithms for keystroke-dynamics. This invention addresses the use of gesture-driven passphrase-like authentication on a gesture-capable input device.

Contextual Definitions: A “gesture-capable input device” can be any device that accepts a user's motion. Examples of such devices include touch-based input screens (including but not limited to kiosks, mobile phones [iPhone], and tablet computers [iPad]) or gyroscopic input devices (including but not limited to immersive [Microsoft Kinect 3D motion] as well as reactive [Wii] controllers). A “stroke” is the capture of a single contiguous motion on a gesture-capable input device. Stroke “depression” delineates the beginning of a stroke. Stroke “release” delineates the termination of a stroke. A “gesture” is a series of strokes use to encapsulate a single meaning; for example, a circle may be performed in a single stroke, while a cross may consist of two strokes. A “gesture-based passphrase” is one or more gestures used to authenticate a user or user action.

Most low-risk biometric (as well as bio-informatics) authentication systems involve use of specialized hardware that must capture/translate/verify user characteristics. This increases the costs of deployment and maintenance; thus reducing Return On Investment (ROI). Other keystroke dynamics algorithms are limited to very specific hardware and/or software requirements. Most are optimized to serve a single static function, and provide a narrow (if any) band of flexibility. Prior art technology deployed by BioPassword (a product of Scout Analytics, Inc) of Washington, USA, relies on an external existing keyboard to produce a digital measurement binding it to a standard user id and password procedures.

Typing biometrics, often referred to as keystroke dynamics, examines the way in which a user types or pushes keys on a keyboard. This method is based on the typing characteristics of the individuals such as durations of keystrokes, and latencies between keystrokes, inter-keystroke times, typing error frequency, force keystrokes, etc. Specifically, keystroke dynamics measures two distinct variables: “dwell time” which is the amount of time you hold down a particular key and “flight time” which is the amount of time it takes a user to travel between keys. These variables are sometimes referred to as a user's “rhythm”. Similarly, gesture biometrics use analogous variables: “dwell time” which is the duration of performing a stroke, and “flight time” which is the amount of time it takes a user to delineate strokes.

Because gesture biometrics uses hardware already found in most gesture-capable computer systems—i.e. touch-sensitive screens and 3D tracking devices—this solution can be considered a software-only solution. The cost of deployment and maintenance are greatly reduced; thus consumers can get a very early Return on Investment (ROI). For example, there is no physical client-side deployment for installations or upgrades, users are not limited to individual or specific workstations, such an implementation supports server and/or workstation managed levels of security, software components allow integration into multiple projects and users may adjust acceptance/enrollment parameters.

### SUMMARY OF THE INVENTION

This invention provides a method and system for gathering data or samples, such as user stroke or gesture timings, analyzing and abstracting the data into a non-repudiated template against which future data or samples can be verified. The invention includes the acts of Data Capture; Template Creation From Enrollment Data; Signature Verification; Template Update From Signature Data; Nonce Profile Creation/Update; and Template Creation From Nonce Profile.

The invention features, in a first embodiment, a method for providing computer-based authentication utilization gesture biometrics, the method comprising the acts of obtaining absolute gesture related data of a user while the user performs a gesture-based passphrase; responsive to said obtained absolute gesture data, analyzing and abstracting the absolute gesture related data into a gesture data template; and verifying future gesture based data entries against the gesture data template.

The method may further include the acts of receiving future absolute gesture related data, and updating said gesture data template with the future absolute gesture data. The absolute gesture related data and the future absolute gesture related data may include a serialized set of gesture timings.

The serialized set of stroke timings may be selected from the group consisting of any timing differential between one stroke's depression and any stroke's release, one stroke's depression to any other stroke's depression, one stroke's release to any other stroke's depression, one stroke's release to any other stroke's release, gesture stroke being“, gesture “stroke completion”, pause of user movement, resumption of user movement, change in direction of the gesture, point of inflection of the gesture and change in gesture due to a boundary condition.

The method may further include the act of performing nonce profiling of the absolute stroke timing data and the absolute future stroke timing data. The method may also further include the act of configuring the nonce profiling into a new gesture-based passphrase.

In another embodiment of the present invention, a method for providing computer-based authentication utilization gesture biometrics comprises the acts of providing a predetermined gesture-based passphrase to be performed by a user for authentication; receiving, by a computer-based authentication utilization gesture biometric device, the predetermined gesture-based passphrase for authentication performed by a user; responsive to said received performed predetermined gesture-based passphrase, deriving, by said computer-based authentication utilization gesture biometric device, gesture characteristics including a plurality of initial gesture related data timings ; responsive to said act of deriving gesture characteristics including obtaining a plurality of initial gesture related data timings, abstracting, by said computer-based authentication utilization gesture biometric device, the initial gesture related data timings into a template for verification at a later time; receiving, by said computer-based authentication utilization gesture biometric device, additional gesture related data entries and determining the gesture related data timings of said additional gesture entries; responsive to said act of receiving additional gesture related data timings, verifying, by said computer-based authentication utilization gesture biometric device, the additional gesture related data timings using said initial gesture related data timings; responsive to said act of verifying, adding, by said computer-based authentication utilization gesture biometric device, the additional gesture related data timings as a signature to the existing template if the verification is approved, thereby increasing the number of gesture related data timings in the template; breaking down the additional gesture related data timings of the additional gesture entries into nonces; and responsive to said breaking down of said additional gesture related data timings, reassembling, by said computer-based authentication utilization gesture biometric device, the nonces into a new gesture-based passphrase.

The gesture characteristics may include any timing differential between one stroke's depression and any stroke's release, one stroke's depression to any other stroke's depression, one stroke's release to any other stroke's depression, one stroke's release to any other stroke's release, gesture stroke being“, gesture “stroke completion”, pause of user movement, resumption of user movement, change in direction of the gesture, point of inflection of the gesture and change due to boundary conditions. The method may further include the act of calculating total calculation points.

In response to the abstracting act, the method may further include the acts of calculating, by said computer-based authentication utilization gesture biometric device, a set of levels to be N−1, wherein N is the length of the gesture-based passphrase; responsive to said calculating act, calculating, by said computer-based authentication utilization gesture biometric device, a mean average, variance, and standard deviation for each calculation point over a number of samples; determining, by said computer-based authentication utilization gesture biometric device, a normalize weighting at each said set of levels based on a spread from a largest percent error to a smallest percent error; calculating, by said computer-based authentication utilization gesture biometric device, a multiplication factor for weighting as a sum of all weights for the entire gesture-based passphrase; calculating, by said computer-based authentication utilization gesture biometric device, the multiplication factor for weighting as a sum of all weights for each level in the gesture-based passphrase; creating a template by storing each calculation point, mean average, standard deviation, percent error, weight for an index normalized over the entire gesture-based passphrase, and weight for an index normalized within each level; responsive to said act of calculating the multiplication factor for weighting as the sum of all weights for each level in the gesture-based passphrase, storing, by said computer-based authentication utilization gesture biometric device, the multiplication factor for weighting as the sum of all weights for each level in the gesture-based passphrase at each breadth level; and responsive to said act of calculating the multiplication factor for weighting as a sum of all weights for each level in the gesture-based passphrase, storing, by said computer-based authentication utilization gesture biometric device, the multiplication factor for weighting as the sum of all weights for the entire gesture-based passphrase and a data timing at a highest level.

The total number of timings may be determined as 2N−1, and wherein N is a number of strokes. The method may further include the acts of adjusting the additional stroke data timings to match the initial data timings in the template; calculating, by said computer-based authentication utilization gesture biometric device, a new mean average, variance, standard deviation, and percent error using an incremental standard deviation formula; recalculating, by said computer-based authentication utilization gesture biometric device, the normalize weighting within each level; recalculating, by said computer-based authentication utilization gesture biometric device, the normalize weighting of each calculating point; recalculating, by said computer-based authentication utilization gesture biometric device, the multiplication factor for weighting as the sum of all weights for the entire gesture-based passphrase; recalculating, by said computer-based authentication utilization gesture biometric device, multiplication factor for weighting as the sum of all weights for each level in the gesture-based passphrase; recreating, by said computer-based authentication utilization gesture biometric device, the mean average, standard deviation, percent error, weight for the index normalized over the entire gesture-based passphrase, and the weight for the index normalized within the level for the template; storing, by said computer-based authentication utilization gesture biometric device, the multiplication factor for weighting as the sum of all weights for the each level in the gesture-based passphrase at each breadth level; and storing, by said computer-based authentication utilization gesture biometric device, the multiplication factor for weighting as the sum of all weights for the entire gesture-based passphrase and the data timing at the highest level.

The verifying act may also include the acts of interpreting a raw score as a value, wherein a smaller value indicates a higher confidence; responsive to said interpreting act, calculating, by said computer-based authentication utilization gesture biometric device, a threshold; and inverting, by said computer-based authentication utilization gesture biometric device, the value to obtain a translated score.

The method may further include the act of refining the template with additional nonces. The method may be performed using client/server technology. The method may be performed using embedded technology.

In yet a further embodiment of the present invention, a method for providing computer-based authentication utilization gesture biometrics comprises the acts of obtaining gesture related timing data of a user while the user performs a gesture-based passphrase, wherein said gesture related timing data is selected from the group consisting of any timing differential between one stroke's depression and any stroke's release, one stroke's depression to any other stroke's depression, one stroke's release to any other stroke's depression, one stroke's release to any other stroke's release- , gesture stroke being“, gesture “stroke completion”, pause of user movement, resumption of user movement, change in direction of the gesture, point of inflection of the gesture and change due to boundary conditions; responsive to said obtained gesture related timing data, analyzing and abstracting, by a computer-based authentication utilization gesture biometric device, the gesture related timing data into a gesture data non-repudiated template; verifying, by said computer-based authentication utilization gesture biometric device, future gesture related timing data against the gesture data non-repudiated template; receiving, by said computer-based authentication utilization gesture biometric device, future stroke timing data; updating, by said computer-based authentication utilization gesture biometric device, said gesture data non-repudiated template with the future gesture related timings data; performing, by said computer-based authentication utilization gesture biometric device, nonce profiling of the stroke timing data and the future gesture related timing data; and configuring, by said computer-based authentication utilization gesture biometric device, the nonce profiling into a new gesture-based passphrase.

Another embodiment of the present invention is a method for providing gesture-based authentication, which comprises the acts of obtaining a gesture related data sample; responsive to said obtained data sample, analyzing and abstracting, by a computer-based authentication utilization gesture biometric device, the data sample into a non-repudiated data sample template; and verifying, by said computer-based authentication utilization gesture biometric device, future data samples data against the non-repudiated data sample template to determine consistency or inconsistency between the future data samples as compared to the non-repudiated data sample template.

The one or more gesture related timings can be captured for each gesture stroke, based on its significance, and wherein gesture related timings include “stroke being”, “stroke completion”, pause of user movement, resumption of user movement, change in direction, point of inflection, and change due to boundary conditions.

The act of verifying may include determining a relationship between gesture related timings and a passphrase, said verifying including a challenge attributes to (N) gestures each containing (M) strokes [where M is a different stroke count for each gesture] with (P) significant attributes [where P is a different significance count for each stroke] and ((M+P)×Q) timings−a uniqueness factor of (N×M×P×((M+P)×Q)).

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a flow chart of the method for providing computer-based authentication utilization biometrics according to the present invention;

FIG. 2 is an exemplary gesture-based passphrase for authentication from which stroke characteristics are gathered according to the present invention;

FIG. 3 is the exemplary gesture-based passphrase for authentication showing timestamps thereon according to FIG. 1;

FIG. 4 is the exemplary gesture-based passphrase for authentication showing dwell and flight times thereon for traditional interval calculations according to FIG. 1; and

FIG. 5 illustrates an exemplary gesture-based passphrase with enhanced breadth calculations for authentication according to the present invention showing the dwell and flight times between adjacent strokes or gestures, between every third stroke, between every fourth stroke, and between a breadth of “2N−1”.

### DETAILED DESCRIPTION OF THE PREFERRED EMBODIMENTS

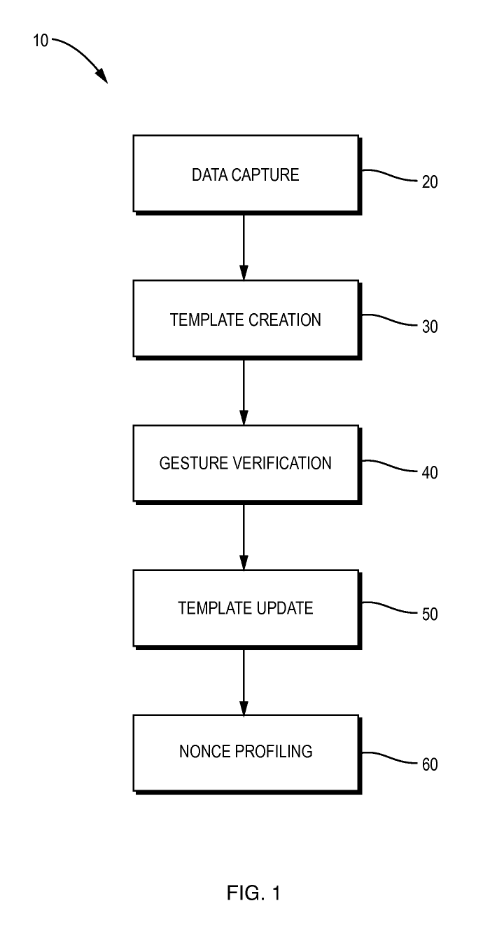

The present invention is a method for providing computer-based authentication and/or pattern recognition in a data sample utilizing biometrics 10, FIG. 1. The method includes the acts of data capture 20, template creation 30, signature verification 40, template update 50, and nonce profiling 60.

Although the present invention will be explained in relation to gesture or stroke recognition, this is not a limitation of the present invention. The present invention looks for patterns in a series of samples to determine consistency or inconsistency within the data sample. The gestures or stroke patterns can refer to one or more movements made by a user. These movements can be made using a hand or other device on a touch screen, such as an iPad or tablet based laptop computer, and can also be achieved using a mouse or other device capable of making movements across a screen of a device. In one embodiment of the present invention, the gestures refer to a movement of one or more fingers of a user across a touch screen of a device. The movement may be a simple shape or design, a series of letters or numbers, or any other movement across the screen of the device or other data input device of an electronic device.

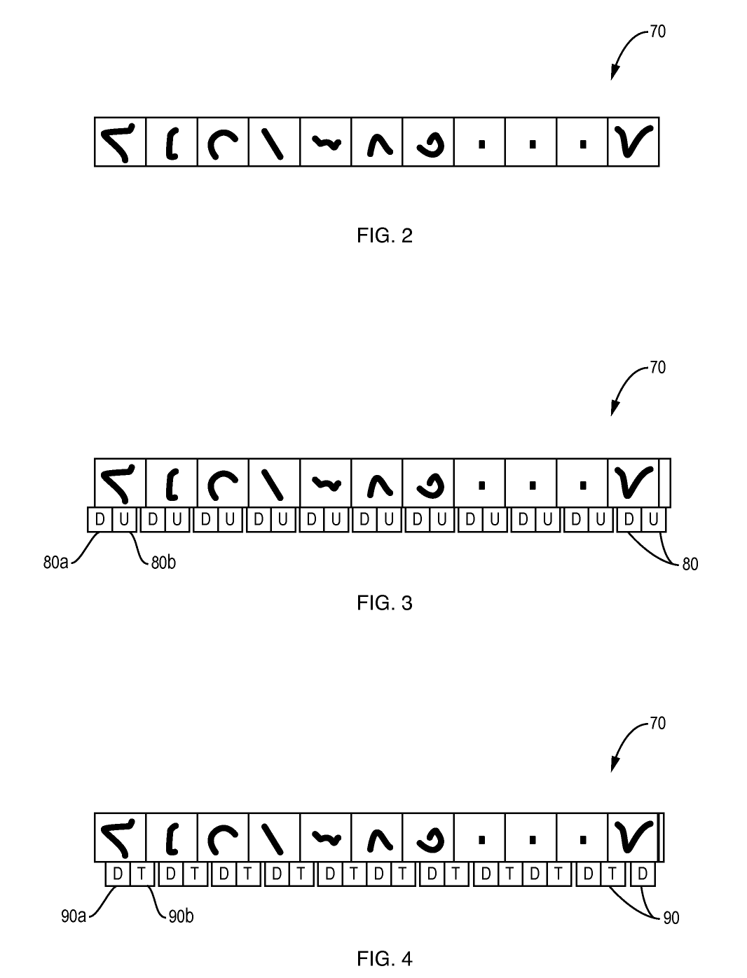

The first act in the method for providing computer-based authentication utilizing gesture biometrics is data capture 20. To capture data 20 to be processed according to the present invention, a gesture-based passphrase 70, FIG. 2, for authorization is created. The gesture-based passphrase may be any of the movements previously described or any other gesture-based passphrase. As or after a user performs the gesture-based passphrase, gesture timestamps are determined, and the stroke or gesture timestamps are used along with other information to determine gesture biometrics of the user. Stroke timestamps include, for example, absolute stroke timing data which may include a serialized set of stroke timings. The set of stroke timings is typically selected from one or more of the following types of any timing differential between: one stroke's depression and any stroke's release; one stroke's depression to any other stroke's depression; one stroke's release to any other stroke's depression; and one stroke's release to any other stroke's release.

The method of the present invention is un-constrained by the relationship of timings to specific actions—i.e. any number (>=2) of timings can be captured for each gesture stroke, based on its significance. With prior art keystroke biometrics, each timing is related to exactly two (and only two) events: key-press and key-release. With the gesture biometrics disclosed and claimed herein, there are analogous timing elements such as “stroke being” and “stroke completion”; but there are also be any number of timings based on significance of the gesture such as, but not limited to: pause of user movement, resumption of user movement, change in direction, point of inflection, change in perceived or actual gesture due to boundary conditions, etc.

A boundary condition is somewhat unique to strokes or gestures because of the computer or other electronic device used to record a gesture. A boundary condition occurs when the stroke or gesture exceeds the area that can be read by the device. For a tablet, for example, it may be the edge of the screen; for the Wii, it may be the range/distance from where it can read. Thus, when a persons' finger (or other element causing the gesture or stroke) goes across a boundary (i.e. beyond the reading ability of the device to record the gesture), the movement across the boundary triggers an interruption in the stroke where there would not necessarily be one. The algorithm therefore must take that into account since this type of interruption may be arbitrary or not, based on whether the person's stroke does/does not cross the boundary in subsequent captures.

The method described herein may further have an additional tier of relationship between timings and a passphrase. In traditional keystroke password challenge, the challenge is attributed to (N) characters—a uniqueness factor of simply (N). With keystroke biometrics, the challenge is attributed to (N) fields of (M) characters each [where M is a different character count for each field] with (2×M) timings−a uniqueness factor of (N×M×(2×M)).

Gesture biometrics in exponentially more complex with a challenge attribute to (N) gestures each containing (M) strokes [where M is a different stroke count for each gesture] with (P) significant attributes [where P is a different significance count for each stroke] and ((M+P)×Q) timings−a uniqueness factor of (N×M×P×((M+P)×Q)).

FIG. 2 is an exemplary gesture-based passphrase 70 for gesture based authentication from which stroke or gesture characteristics are gathered according to the present invention.

FIG. 3 is the exemplary gesture-based passphrase 70 for gesture based authentication according to FIG. 2 showing timestamps 80 thereon. To support biometric analysis, all algorithms must capture the timestamp when a stroke is pressed or gesture initiated “D” 80a and the timestamp when a stroke is released or gesture completed “U” 80b. Specifically, the time between a single stroke's press 80a and release time 80b is called dwell time “D” 90a. The time between one stroke release 80b and the next stroke press 80a is called travel or flight time “T” 90b (hereinafter “flight time”) as shown in FIG. 4.

FIG. 4 is the exemplary gesture-based passphrase 70 for authentication showing the timestamp data, which is abstracted further. Most algorithms use this data to calculate either relative or absolute timing. The present invention preferably utilizes an algorithm that uses absolute timings. For this type of data, an algorithm mathematically obtains 2N−1 total calculation points (TCPs) where “N” is the number of strokes in the gesture-based passphrase.

The second act in the method for providing computer-based authentication utilizing gesture biometrics according to the present invention is the creation of a template 30. There is an enrollment period during which time a user performs the gesture-based passphrase 70. The user is required to perform the gesture-based passphrase 70 a number of times. During the enrollment period, multiple data timings are obtained. This data is abstracted into a template for later verification. The details of template creation 30 are proprietary to each algorithm and described further herein below.

The third act in the method for providing computer-based authentication utilizing gesture biometrics according to the present invention is signature verification 40. As will happen with most algorithms, the data timings for a gesture-based passphrase 70 are gathered only once during authentication and sent to a processing engine for verification. The details of signature verification 40 are proprietary to each algorithm and examples are disclosed herein.

The fourth act in the method for providing computer-based authentication utilizing gesture biometrics is updating the template 50. Unlike many other behavioral biometric algorithms, the present invention provides the capability of embedding a signature (i.e., additional data timings) into an existing template to increase the “strength” or accuracy of the template. The strength of the template is increased by increasing the sample size of data timings from which the template is created.

The present invention has unique features including a new set of algorithms. Specifically, the algorithms of the present invention utilize an extended breadth of timing data. Traditionally, most prior art algorithms work on adjacent keystroke data timings to provide biometric analysis. In contrast, the present invention defines multiple degrees and more total calculation points than traditional algorithms. For example, the present invention may define the movements of one or more fingers across a touch screen of a device. In defining these movements, the algorithm will calculate the multiple degrees and calculation points of each finger and each movement of each finger. Further and contrary to traditional algorithms, the present invention does not make distinctions between timings that are stroke presses 80a or stroke releases 80b. The present invention uses timings that are done by “breadth” (or in “levels”).

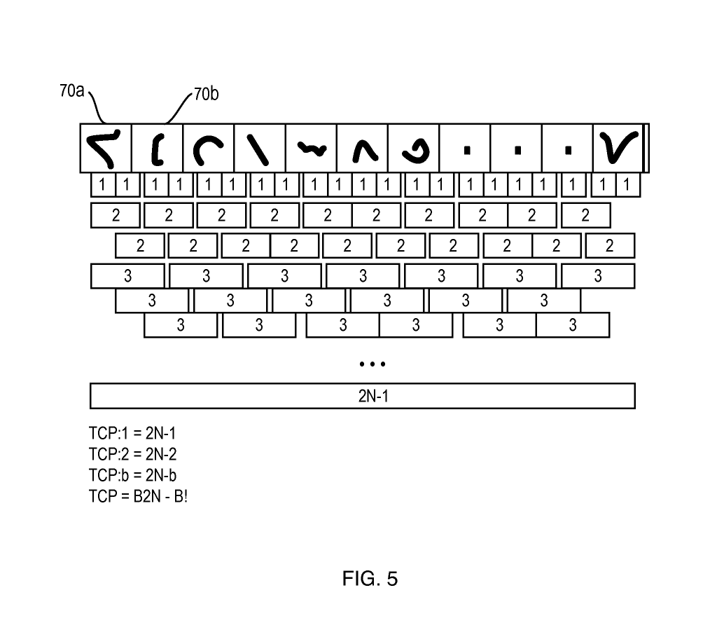

As shown in FIG. 5, this means that not only does the present invention analyze the time it takes a user between adjacent strokes or gestures in a gesture-based passphrase (e.g., gesture 70a and the gesture in 70b), but it also tracks the time it takes for the user between every third gesture or stroke (e.g., 70a and 70c), then every fourth gesture or stroke (e.g., 70a and 70d), and all the way to a breadth of “2N−1”.

In addition, and as mentioned above, other gesture based characteristics which]h are not found in simple keystrokes may be measured including, but not limited to: pause of user movement, resumption of user movement, change in direction, point of inflection, change due to boundary conditions, etc.

Generally, the larger the sample size, the better the template. Traditionally, all biometric technologies rely on a minimum enrollment set of “S” samples to generate a verification template. However, the present invention utilizes adaptive template technology. The adaptive template technology expands this paradigm to allow samples to be dynamically added to the verification template. This means that an initial minimum enrollment of samples is provided, then over time as a user enters their gesture -based passphrase, the template will alter or change in accordance with minor variations and changes over time. This provides two advantages. Specifically, since the sample size “S” is ever increasing, the template gets more secure or stronger, and over time, the template will adapt to long-term changes in gesture behavior, possibly eliminating the need to re-enroll the user.

The fifth act in the method for providing computer-based authentication utilizing gesture biometrics is nonce profiling 60. Nonce profiling 60 utilizes an algorithm that is explained hereinafter. It is based on the cumulative characteristics between any number of sequential strokes. In speech technology, a specific discernable piece of speech is known as a “nonce”. In this realm, a nonce could also be used to refer to a specific discernable pattern between any two (or N) strokes.

Although many existing algorithms use a template based on the entire gesture-based passphrase 70, the nonce profiling 60 act takes existing and past enrollment data, broken up into nonces, and re-assembles them for a new gesture-based passphrase (if there are enough nonces available to do so). Theoretically, when a user changes his/her gesture-based passphrase, he/she may not need to re-enroll because the nonce profile can auto-generate a template from an existing library.

The combination of the prior two feature sets allows users, over time, to avoid re-enrolling because the initial template (i.e., template creation 30) is created from nonces, and the template is refined via adaptive updates (i.e., template updates 50). This creates a new breed of biometric implementations, known as auto-enrollment extensions.

In alternative embodiments of the present invention, this architecture may be applied to various hardware and software platforms because of the computer environments. Although the architecture itself is defined to be object-oriented, conventional programming methods may be used to emulate both the object-oriented function overloading techniques. Products may be built on this engine and are available from bioChec of Stony Point, NY. In another alternative embodiment, integration with single-sign-on solutions (hereinafter “SSO”) is used. This embodiment implements the bioChec gesture-based technology in an applet. The applet is designed for integration into existing SSO products.

The signature verification 40 becomes electronic forensic evidence of user access. This means, the signature hash created by this gesture biometric algorithm can prove both identity and non-repudiation of the user who was authenticated.

The following Table A is a “Variable Legend” for the algorithms that are used in performing the method for gathering user stroke timings, analyzing and abstracting the timings data into a non-repudiated template against which future stroke data timings are verified. In addition, a detailed description of how the templates are created 30, signatures are verified 40, and the scoring is determined is provided hereinafter.

TABLE A
VARIABLE LEGEND

S = number of samples given
N = length of gesture-based passphrase in strokes
Z = number of gesture-based passphrase fields
CP = Calculation Point
TCP = Total Calculation Points
TCP:b = TCP only for a particular level
CP:b = Specific CP for an index within a level
VAR = variance
STDDEV = standard deviation
AVG = Mean (Average)
PERCERR = Percent Error
TS = timing scale
B = Breadth (aka Level) number of linear timings skipped for
differential calculations
WT = Weight for an index normalized over the entire passphrase
WT:b = Weight normalized within a level
MFW = Multiplication factor for weighting
MFW:b = MFW within a particular level
ED = explicit deviance of a value to a VAR
WD = explicit deviance with WT applied
WD:b = explicit deviance with WT:b applied
TWD = total weighted deviance
TWD:b = total weighted deviance for a particular level
LD = leveled deviance
LD:b = leveled deviance for a particular level
RAW = raw score
TSCORE = translated score

After the first act of data capture 20 is performed in the method for providing computer-based authentication utilizing gesture biometrics, the second act of template creation 30 from the captured or enrollment data 20 is performed.

The act of creating a template 30 includes calculating a set of “levels” to be N−1 (where N is the length or number of gestures in the specific field) for each gesture-based passphrase field. The MEAN, VAR, STDDEV and PERCERR for each Calculation Point (hereinafter “CP”) over the captured Samples (hereinafter “S”) are calculated. Enhancing the effect of consistent stroke patterns over inconsistent patterns is done through “normalized weighting.” Consistency of a specific timing is determined by the percent error calculation (over a number of samples) as compared with the percent error calculation for other timings in the captured data. (Note: Because the consistency is calculated relative to the specific captured dataset, the same timing presented in a different capture set will result in a different consistency rating. This “feature” prevents the creation of faux template data from disparate capture datasets.) The Normalize Weighting for each CP, based on spread from largest PERCERR (where WT:x is given a lowest value of 1) to smallest PERCERR (where WT:y is given highest value of TCP/2), is calculated. The Normalize Weighting, within each level based on spread from largest PERCERR (where WT:b:x is given lowest value of 1) to smallest PERCERR (where WT:b:y is given highest value of TCP:b/2), is calculated. The MFW is then calculated as the sum of all weights for the entire passphrase is calculated. The MFW:b, as the sum of all weights within a particular level, is calculated. The template storing for each CP: MEAN, STDDEV, PERCERR, WT, WT:b is created. At each breadth level, the MFW:b is stored. (Breadth defines the number of linear timings skipped for differential calculations. A grouping of all differential calculations with the same breadth is known as “breadth level”.) At the highest level, the MFW and Timing Scale, used for calculations, are stored. The VAR is not stored to prevent artificial creation of signatures.

The weighting is a relation of the PERCERR values across the entries in the passphrase 70 only. Weighting gives higher validity to consistent gesture performance values than inconsistent gesture performance values. Thus, it is always the consistency, not the speed, at which one performs a gesture which affects the final outcome.

The template is updated from signature data as additional gestures or strokes are received. The timing is adjusted to match the template timing scale. For each signature CP and template MEAN, STDDEV and PERCERR, a new MEAN, VAR, STDDEV and PERCERR are calculated given the formula in the “Incremental STDDEV” section. The Normalize Weighting of each CP is recalculated. The Normalize Weighting within each level is recalculated. The MFW as the sum of all weights for the entire passphrase is calculated. The MFW:b as the sum of all weights within a particular level is calculated. The template storing for each MEAN, STDDEV, PERCERR, WT, WT:b is recreated. The MFW:b is stored at each breadth level. At the highest level, the MFW is stored.

The next act or third act in the method for providing computer-based authentication utilizing gesture biometrics is gesture verification 70. The act of gesture verification 40 includes adjusting the timing to match the template timing scale (hereinafter “TS”). The explicit deviance (hereinafter “ED”) for each CP in the gesture “signature” is calculated as the difference from the template variance over the STDDEV. The weighted deviances (i.e., WD and WD:b) for each CP in the gesture signature are calculated as the ED*WT and ED*WT:b, respectively. The total weighted deviances (hereinafter “TWD and TWD:b”) are calculated as the sum of all WD and WD:b, respectively. The leveled deviances (hereinafter “LD and LD:b”) are calculated by dividing the WD/MFW and WD:b/MFW:b, respectively. The RAW score is the calculated average of the master leveled deviances (hereinafter “LD”) and all the breadth leveled deviances (hereinafter “LD:b”).

Next, the act of verifying the score is performed. The raw score is interpreted as giving a higher confidence match as the value approaches (0) zero. A translated or scaled score inverts this value after adjusting for a threshold using the following formula: scale*(threshold−score)/threshold. Although a score closer to zero is an indication that the user is the user who created the template, a perfect score is almost impossible and theoretically improbable. Thus, a perfect score (or a score close to perfect) is an indication that the sample data is replayed; thus is considered a fraudulent attempt and rejected.

The fifth act in the method for providing computer-based authentication utilizing gesture biometrics is nonce profiling 60. The act of nonce profiling 60 includes adjusting the timing to match the template timing scale. For each gesture-based passphrase field, the set of “levels” is calculated to be N−1 (where N is the length of the specific field).

For a new profile, the MEAN, VAR, STDDEV and PERCERR are calculated for each Calculation Point (CP) over number of Samples (S). For an existing profile, a new MEAN, VAR, STDDEV and PERCERR for each Calculation Point (CP) are calculated using the “Incremental STDDEV” formula.

After calculating the MEAN, VAR, STDDEV and PERCERR for a new or existing profile, the template storing for each CP: MEAN, STDDEV, PERCERR and Timing Scale (TS) is calculated. The VAR is not stored to prevent artificial creation of signatures. In addition, the nonce is stored and consists of the following indexing data: 1) the Timing Point 1 having the Stroke Value (circle, vertical, diagonal, dot, et al), Input Identifier (Left Hand, finger #1, finger #2, et al), and the Press/Release Flag; 2) the Timing point 2 having the Stroke Value, Input Identifier, Press/Release Flag; 3) Breadth of timestamp interval; 4) Positional Flags to indicate the start of word boundary, end of a word boundary, and start on even/odd boundary template creation from the nonce profile.

The desired gesture passphrase for profile entries based on the indexing data is analyzed. A determination is made as to the existence of a critical number of profiles and the existence of a sufficient number of samples in each profile. The MEAN, VAR, STDDEV and PERCERR from the profile are used to weight each Calculation Point (CP) over number of Samples (S) in the profile. Normalize Weighting of each CP based on spread from largest PERCERR (where WT:x is given lowest value of 1) to smallest PERCERR (where WT:y is given highest value of TCP/2) is performed. Normalize Weighting within each level based on spread from largest PERCERR (where WT:b:x is given lowest value of 1) to smallest PERCERR (where WT:b:y is given highest value of TCP:b/2) is performed. The MFW as the sum of all weights for the entire passphrase is calculated. The MFW:b as the sum of all weights within a particular level is also calculated. The template storing for each CP: MEAN, STDDEV, PERCERR, WT, WT:b are created. At each breadth level, the MFW:b is stored. At the highest level, the MFW and Timing Scale (TS) used for calculations are stored. The VAR is not stored to prevent artificial creation of signatures. The weighting is a relation of the PERCERR values across the entries in the passphrase only. Weighting for a particular nonce changes depending on the passphrase it is used in.

There is an Incremental STDDEV Formula according to another feature of the present invention. The STDDEV (N+1) algorithm is used to support “biased” (sample-based) and “non-biased” (population-based) calculations. The Formula Key for the calculations is as follows: D=sample data; oN=old sample size; oM=old mean; oV=old variance; oS=old std dev; nN=new sample size; nM=new mean; nV=new variance; and nS=new standard deviation stddev. The following calculations are performed:

New mean (nM) calculation:

$$nM = \frac{( ( oM * oN ) + D )}{( nN )}$$

Original variance (oV) calculation:

oV=pow(oS,2)

New variance (nV) calculation:

$$nV = \frac{( oN * ( pow ( oM - nM , 2 ) + oV ) ) + pow ( D - nM , 2 )}{( nN - 1 )}$$

To calculate the variance using the “biased” method, the only difference in the calculation is that the denominator (nN−1) is replaced with just (nN).

New standard deviation (nS) calculation:

nS=SQRT(nV)

Accordingly, the present invention provides a novel system and method for gathering various gesture parameters and for analyzing and abstracting the data into a fail-safe template against which future stroke timings can be compared and positively verified.

Modifications and substitutions by one of ordinary skill in the art are considered to be within the scope of the present invention, which is not to be limited except by the allowed claims and their legal equivalents.

What I claim is:

1. A method for providing computer-based authentication utilization gesture biometrics, the method comprising the acts of:
obtaining absolute gesture related data of a user while the user performs a gesture-based passphrase;
responsive to said obtained absolute gesture data, analyzing and abstracting the absolute gesture related data into a gesture data template; and
verifying future gesture based data entries against the gesture data template.

2. The method according to claim 1 further including the acts of receiving future absolute gesture related data, and updating said gesture data template with the future absolute gesture data.

3. The method according to claim 2 wherein the absolute gesture related data and the future absolute gesture related data include a serialized set of gesture timings.

4. The method according to claim 3 wherein said serialized set of stroke timings is selected from the group consisting of any timing differential between one stroke's depression and any stroke's release, one stroke's depression to any other stroke's depression, one stroke's release to any other stroke's depression, one stroke's release to any other stroke's release, gesture stroke being“, gesture “stroke completion”, pause of user movement, resumption of user movement, change in direction of the gesture, point of inflection of the gesture and change in gesture due to a boundary condition.

5. The method according to claim 4 further including the act of performing nonce profiling of the absolute stroke timing data and the absolute future stroke timing data.

6. The method according to claim 5 further including the act of configuring the nonce profiling into a new gesture-based passphrase.

7. A method for providing computer-based authentication utilization gesture biometrics, the method comprising the acts of:
providing a predetermined gesture-based passphrase to be performed by a user for authentication;
receiving, by a computer-based authentication utilization gesture biometric device, the predetermined gesture-based passphrase for authentication performed by a user;
responsive to said received performed predetermined gesture-based passphrase , deriving, by said computer-based authentication utilization gesture biometric device, gesture characteristics including a plurality of initial gesture related data timings ;
responsive to said act of deriving gesture characteristics including obtaining a plurality of initial gesture related data timings, abstracting, by said computer-based authentication utilization gesture biometric device, the initial gesture related data timings into a template for verification at a later time;
receiving, by said computer-based authentication utilization gesture biometric device, additional gesture related data entries and determining the gesture related data timings of said additional gesture entries;
responsive to said act of receiving additional gesture related data timings, verifying, by said computer-based authentication utilization gesture biometric device, the additional gesture related data timings using said initial gesture related data timings;
responsive to said act of verifying, adding, by said computer-based authentication utilization gesture biometric device, the additional gesture related data timings as a signature to the existing template if the verification is approved, thereby increasing the number of gesture related data timings in the template;
breaking down the additional gesture related data timings of the additional gesture entries into nonces; and
responsive to said breaking down of said additional gesture related data timings, reassembling, by said computer-based authentication utilization gesture biometric device, the nonces into a new gesture-based passphrase.

8. The method according to claim 7 wherein the gesture characteristics include any timing differential between one stroke's depression and any stroke's release, one stroke's depression to any other stroke's depression, one stroke's release to any other stroke's depression, one stroke's release to any other stroke's release, gesture stroke being“, gesture “stroke completion”, pause of user movement, resumption of user movement, change in direction of the gesture, point of inflection of the gesture and change due to boundary conditions.

9. The method according to claim 8, further including the act of calculating total calculation points.

10. The method according to claim 7, responsive to said abstracting act, further comprising the acts of:
calculating, by said computer-based authentication utilization gesture biometric device, a set of levels to be N−1, wherein N is the length of the gesture-based passphrase;
responsive to said calculating act, calculating, by said computer-based authentication utilization gesture biometric device, a mean average, variance, and standard deviation for each calculation point over a number of samples;
determining, by said computer-based authentication utilization gesture biometric device, a normalize weighting at each said set of levels based on a spread from a largest percent error to a smallest percent error;
calculating, by said computer-based authentication utilization gesture biometric device, a multiplication factor for weighting as a sum of all weights for the entire gesture-based passphrase;
calculating, by said computer-based authentication utilization gesture biometric device, the multiplication factor for weighting as a sum of all weights for each level in the gesture-based passphrase;
creating a template by storing each calculation point, mean average, standard deviation, percent error, weight for an index normalized over the entire gesture-based passphrase, and weight for an index normalized within each level;
responsive to said act of calculating the multiplication factor for weighting as the sum of all weights for each level in the gesture-based passphrase, storing, by said computer-based authentication utilization gesture biometric device, the multiplication factor for weighting as the sum of all weights for each level in the gesture-based passphrase at each breadth level; and
responsive to said act of calculating the multiplication factor for weighting as a sum of all weights for each level in the gesture-based passphrase, storing, by said computer-based authentication utilization gesture biometric device, the multiplication factor for weighting as the sum of all weights for the entire gesture-based passphrase and a data timing at a highest level.

11. The method according to claim 8 wherein the total number of timings are determined as 2N−1, and wherein N is a number of strokes.

12. The method according to claim 10, further including the acts of:
adjusting the additional stroke data timings to match the initial data timings in the template;
calculating, by said computer-based authentication utilization gesture biometric device, a new mean average, variance, standard deviation, and percent error using an incremental standard deviation formula;
recalculating, by said computer-based authentication utilization gesture biometric device, the normalize weighting within each level;
recalculating, by said computer-based authentication utilization gesture biometric device, the normalize weighting of each calculating point;
recalculating, by said computer-based authentication utilization gesture biometric device, the multiplication factor for weighting as the sum of all weights for the entire gesture-based passphrase;
recalculating, by said computer-based authentication utilization gesture biometric device, multiplication factor for weighting as the sum of all weights for each level in the gesture-based passphrase;
recreating, by said computer-based authentication utilization gesture biometric device, the mean average, standard deviation, percent error, weight for the index normalized over the entire gesture-based passphrase, and the weight for the index normalized within the level for the template;
storing, by said computer-based authentication utilization gesture biometric device, the multiplication factor for weighting as the sum of all weights for the each level in the gesture-based passphrase at each breadth level; and
storing, by said computer-based authentication utilization gesture biometric device, the multiplication factor for weighting as the sum of all weights for the entire gesture-based passphrase and the data timing at the highest level.

13. The method according to claim 7 wherein the verifying act includes the acts of:
interpreting a raw score as a value, wherein a smaller value indicates a higher confidence;
responsive to said interpreting act, calculating, by said computer-based authentication utilization gesture biometric device, a threshold; and
inverting, by said computer-based authentication utilization gesture biometric device, the value to obtain a translated score.

14. The method according to claim 7 further comprising the act of refining the template with additional nonces.

15. The method according to claim 7 wherein the method is performed using client/server technology.

16. The method according to claim 7 wherein the method is performed using embedded technology.

17. A method for providing computer-based authentication utilization gesture biometrics, the method comprising the acts of:
obtaining gesture related timing data of a user while the user performs a gesture-based passphrase, wherein said gesture related timing data is selected from the group consisting of any timing differential between one stroke's depression and any stroke's release, one stroke's depression to any other stroke's depression, one stroke's release to any other stroke's depression, one stroke's release to any other stroke's release-, gesture stroke being“, gesture “stroke completion”, pause of user movement, resumption of user movement, change in direction of the gesture, point of inflection of the gesture and change due to boundary conditions;
responsive to said obtained gesture related timing data, analyzing and abstracting, by a computer-based authentication utilization gesture biometric device, the gesture related timing data into a gesture data non-repudiated template;
verifying, by said computer-based authentication utilization gesture biometric device, future gesture related timing data against the gesture data non-repudiated template;
receiving, by said computer-based authentication utilization gesture biometric device, future stroke timing data;
updating, by said computer-based authentication utilization gesture biometric device, said gesture data non-repudiated template with the future gesture related timings data;
performing, by said computer-based authentication utilization gesture biometric device, nonce profiling of the stroke timing data and the future gesture related timing data;
and configuring, by said computer-based authentication utilization gesture biometric device, the nonce profiling into a new gesture-based passphrase.

18. A method for providing gesture-based authentication, the method comprising the acts of:
obtaining a gesture related data sample;
responsive to said obtained data sample, analyzing and abstracting, by a computer-based authentication utilization gesture biometric device, the data sample into a non-repudiated data sample template; and
verifying, by said computer-based authentication utilization gesture biometric device, future data samples data against the non-repudiated data sample template to determine consistency or inconsistency between the future data samples as compared to the non-repudiated data sample template.

19. The method according to claim 18 wherein one or more gesture related timings can be captured for each gesture stroke, based on its significance, and wherein gesture related timings include “stroke being”, “stroke completion”, pause of user movement, resumption of user movement, change in direction, point of inflection, and change due to boundary conditions.

20. The method according to claims 18 wherein said act of verifying includes determining a relationship between gesture related timings and a passphrase, said verifying including a challenge attributes to (N) gestures each containing (M) strokes [where M is a different stroke count for each gesture] with (P) significant attributes [where P is a different significance count for each stroke] and ((M 30 P)×Q) timings−a uniqueness factor of (N×M×P×((M+P)×Q)).
